(19) United States
(12) Patent Application Publication
(10) Pub. No.: US 2007/0167076 A1
(43) Pub. Date: Jul. 19, 2007

(54) Electrical connector having protective shutter

(76) Inventors: Seung-Jong Seh, Gyunggi-do (KR); Yong-Soo Kim, Kyunggi-Do (KR); Jung-Hoon Kim, Kyunggi-Do (KR)

Correspondence Address: Stephen Z Weiss;Molex Incorporated, 2222 Wellington Court, Lisle, IL, 60532, US

(21) Appl. No.: 10/569,839

(22) PCT Filed: Sep. 7, 2004
(86) PCT No.: PCT/US04/28885

§ 371 Date: Feb. 8, 2007

(30) Foreign Application Priority Data
Sep. 9, 2003 (KR) 10-2003-0063025
Sep. 9, 2003 (KR) 10-2003-0063026
Sep. 9, 2003 (KR) 10-2003-0063027

(51) Int. Cl. H01R 13/648

(52) U.S. Cl. 439/607

(57) ABSTRACT

An electrical connector is provided for mating with a complementary connecting device having a mating portion. The connector includes a shell having an internal cavity and a front opening for receiving the mating portion of the complementary connecting device inserted into the cavity. A housing is mounted in at least a rear portion of the shell and has a mating portion extending forwardly into the cavity. A shutter is slidably mounted in the shell and is formed with a passage for receiving the forwardly extending mating portion of the housing therethrough. When the mating portion of the complementary connecting device is inserted into the cavity through the front opening in the shell, the shutter is slidably pushed rearwardly from a forward position to a rear position whereat the mating portion of the housing passes through the passage in the shutter for engaging the mating portion of the complementary connecting device.

### FIELD OF THE INVENTION

This invention generally relates to the art of electrical connectors and, particularly, to a connector having a shutter for protecting an opening to a mating cavity.

### BACKGROUND OF THE INVENTION

A typical electrical connector includes some form of insulating or dielectric housing mounting a plurality of conductive terminals for contacting the terminals of a complementary connecting device or mating connector. For instance, a male or plug connector may be provided for mating with a female or receptacle connector to establish electrical transmission through the mated connector assembly. The receptacle connector has an open receptacle for receiving the plug connector. In some instances, a movable shutter is used to close the opening to the receptacle to protect the interior components/terminals of the receptacle connector from damage by extraneous objects. The plug connector moves the shutter from its normally closed position to an open position during mating. Typically, the shutter will automatically move back to its closed position upon unmating of the connectors, as by a spring bias.

FIGS. 1 and 2 show a prior art electrical connector, generally designated 10, for mating with a complementary mating connector, generally designated 12. Connector 10 will be called the receptacle connector, and connector 12 will be called the plug connector. The receptacle connector is mounted on an electronic apparatus such as a cellular phone, a camcorder, an MP3 player, a digital camera, a computer or the like to transmit and receive data to/from an electrically connected external device or to charge a battery, by means of plug connector 12. In the illustration herein, connector 10 is mounted on a conventional cellular phone 14.

Prior art connector 10 includes a housing, generally designated 16, substantially surrounded by a shell, generally designated 18. The housing may be molded of plastic material, for instance, and the shell may be stamped and formed of sheet metal material.

Housing 16 of receptacle connector 10 includes a forwardly projecting mating portion 16a in the form of a flat platform. The housing mounts a plurality of terminals, and the terminals have contact portions 20a on one side of mating platform 16a, along with tail portions 20b (FIG. 2) for connection to appropriate circuit traces on a printed circuit board. The housing has a pair of upstanding rear posts 16b and a pair of upstanding front posts 16c. Finally, the housing has a pair of cut-outs or notches 16d at the bottom front comers thereof.

Metal shell 18 of receptacle connector 10 defines a receptacle 22 at the front of the connector. The shell has a pair of rear, outwardly projecting mounting ears 18a at opposite sides thereof, along with a pair of depending grounding feet 18b which are inserted into holes in the printed circuit board for connection to appropriate grounding traces on the board. The grounding feet define mounting comers 18c at the tops thereof. A pair of through holes 18d are formed in opposite side walls of the shell. A plurality of tabs 18e are formed at the top front edge of the shell and are bent downwardly as can be seen in FIG. 1.

Housing 16 is mounted into the rear of shell 18 in the direction of arrow “A” (FIG. 1). When fully mounted, the mounting corners 18c of grounding feet 18b of the shell seat into notches 16d of the housing. Mounting ears 18a of the shell snap into the spaces between front and rear posts 16c and 16b, respectively, of the housing. When the housing is assembled into the shell, mating platform 16a (along with terminal contacts 20a) project into receptacle 22 of the shell.

Plug connector 12 includes a housing 12a and a forwardly projecting mating portion 12b having latch projections 12c at opposite sides thereof. The latch projections are provided on the ends of leaf springs 24 interlocked to a release buttons 26. Connector 12 is terminated to an electrical cable 27 which has a plurality of conductors or wires that are terminated to terminals within the connector. The terminals have contact portions for engaging contact portions 20a of the terminals terminated within receptacle connector 10.

When plug connector 12 is mated within receptacle connector 10, latch projections 12c snap into openings 18d in the side walls of shell 18 of receptacle connector 10. This latches the connectors in mated condition. When it is desired to unmate the connectors, release buttons 26 are depressed and leaf springs 24 move latch projections 12c out of openings 18d to allow the connectors to be unmated.

In prior art connector 10, an independent or separate cap or shutter 28 is used to close the front of receptacle 22 behind tabs 18e of shell 18. The cap protects the interior of the connector, particularly mating platform 16a and contact portions 20a of the terminals. The cap is separate from the connector and must be removed in order to mate the connector with mating connector 12. The cap is quite small and difficult to manipulate. Other problems are encountered with the small cap, such as it being quite easy to lose the cap. The present invention is directed to solving these problems by providing a shutter which is mounted within the receptacle connector for movement relative thereto in a unique shutter mechanism.

### SUMMARY OF THE INVENTION

An object, therefore, of the invention is to provide a new and improved shutter mechanism for an electrical connector.

In the exemplary embodiment of the invention, an electrical connector is provided for mating with a complementary connecting device having a mating portion. The connector includes a shell having an internal cavity and a front opening for receiving the mating portion of the complementary connecting device inserted into the cavity. A housing is mounted in at least a rear portion of the shell and has a mating portion extending forwardly into the cavity. A shutter is slidably mounted in the shell and is formed with a passage for receiving the forwardly extending mating portion of the housing therethrough. When the mating portion of the complementary connecting device is inserted into the cavity through the front opening in the shell, the shutter is slidably pushed rearwardly from a forward position to a rear position whereat the mating portion of the housing passes through the passage in the shutter for engaging the mating portion of the complementary connecting device.

According to one aspect of the invention, spring means are provided for biasing the shutter toward its forward position. In the preferred embodiment, the spring means comprises a coil spring extending in a direction between the housing and the front opening in the shell. As disclosed herein, the shutter is elongated, and a pair of the coil springs are provided at opposite ends of the shutter.

According to another aspect of the invention, the shell and the coil spring are of metal material and the housing includes a through hole through which a rear end of the coil spring extends into engagement with a portion of the shell. Therefore, the coil springs are grounded to the shell which, in turn, is grounded to a printed circuit board to prevent signal distortion resulting from induced current and/or magnetic flux.

Other features of the invention include the shutter having a rearwardly extending rod projecting into a front end of the coil spring(s). Front-to-rear interengaging guide means are provided between the shell and the shutter. As disclosed herein, the guide means are provided by a guide slot in the shell receiving a guide boss on the shutter.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIGS. 1 and 2 are perspective views depicting the prior art connector as described in the Background, above;

FIG. 3 is a top front perspective view of an electrical connector incorporating the concepts of the invention;

FIG. 4 is a bottom rear perspective view of the connector of FIG. 3;

FIG. 5 is a bottom plan view of the connector;

FIG. 6 is a top exploded perspective view of the connector;

FIG. 7 is a bottom exploded perspective view of the connector;

FIG. 8A is a perspective view of the metal shell;

FIG. 8B is a bottom plan view of the metal shell;

FIG. 9A is a perspective view of the shutter;

FIG. 9B is a rear elevational view of the shutter;

FIG. 10A is a perspective view of the housing;

FIG. 10B is a front elevational view of the housing;

FIG. 11 is a horizontal section taken generally along line A-A in FIG. 3;

FIG. 12 is a vertical section taken generally along line B-B in FIG. 4; and

FIGS. 13A and 13B are perspective views showing the connection of the connector with a complementary connecting device or mating connector.

### DETAILED DESCRIPTION OF THE PREFERRED EMBODIMENT

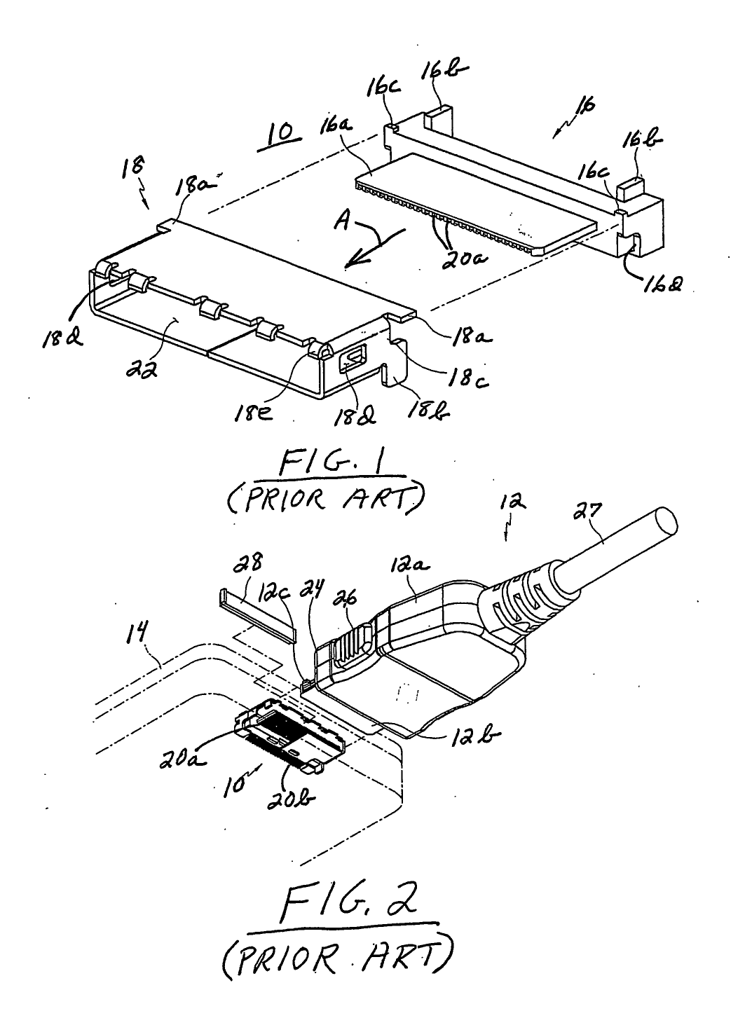

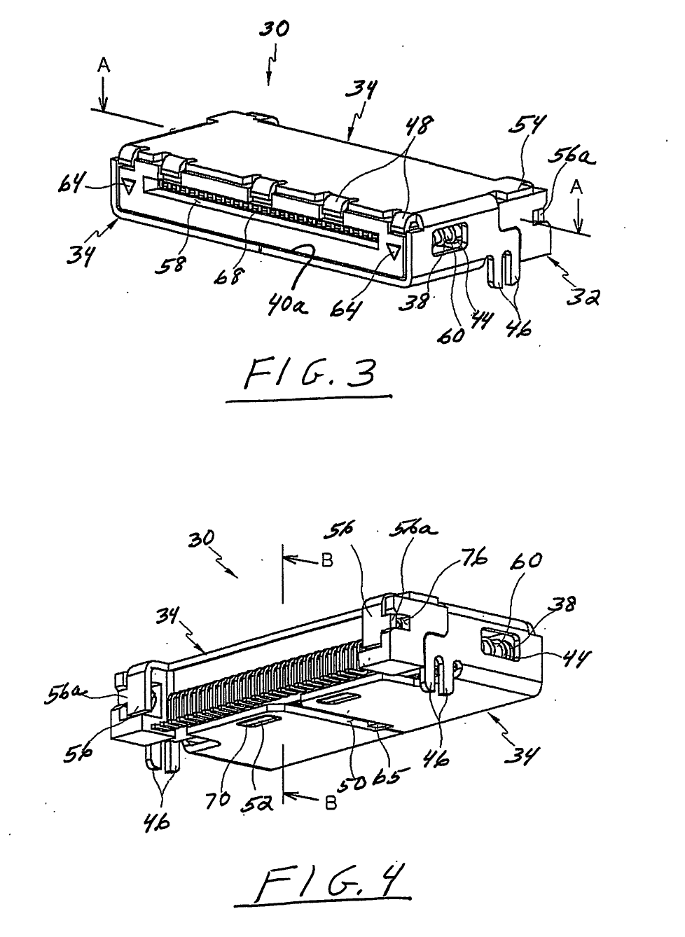

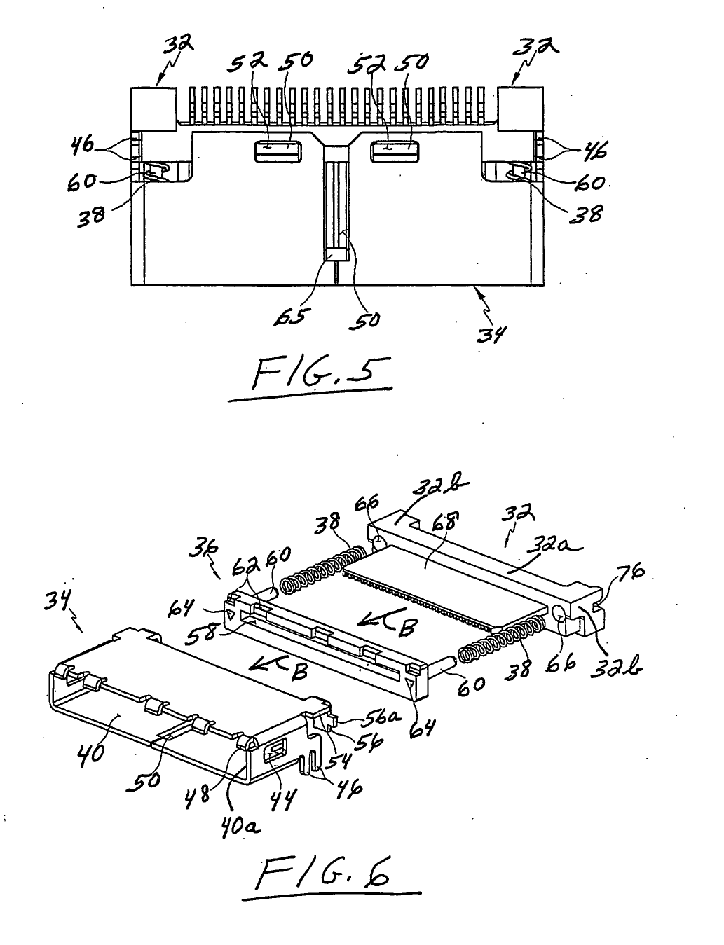

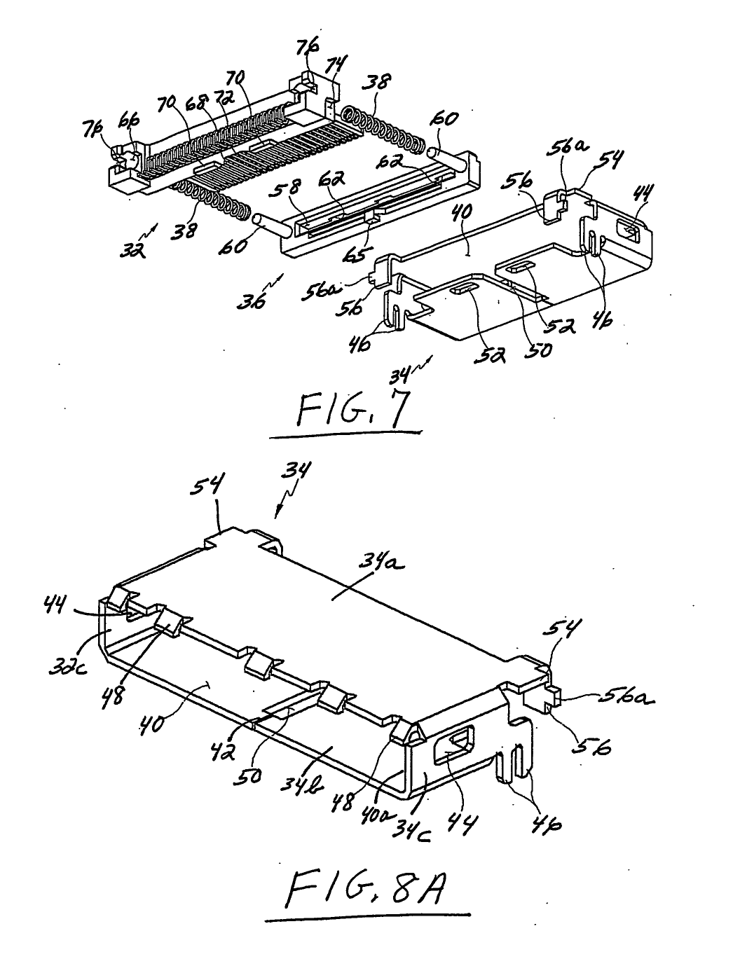

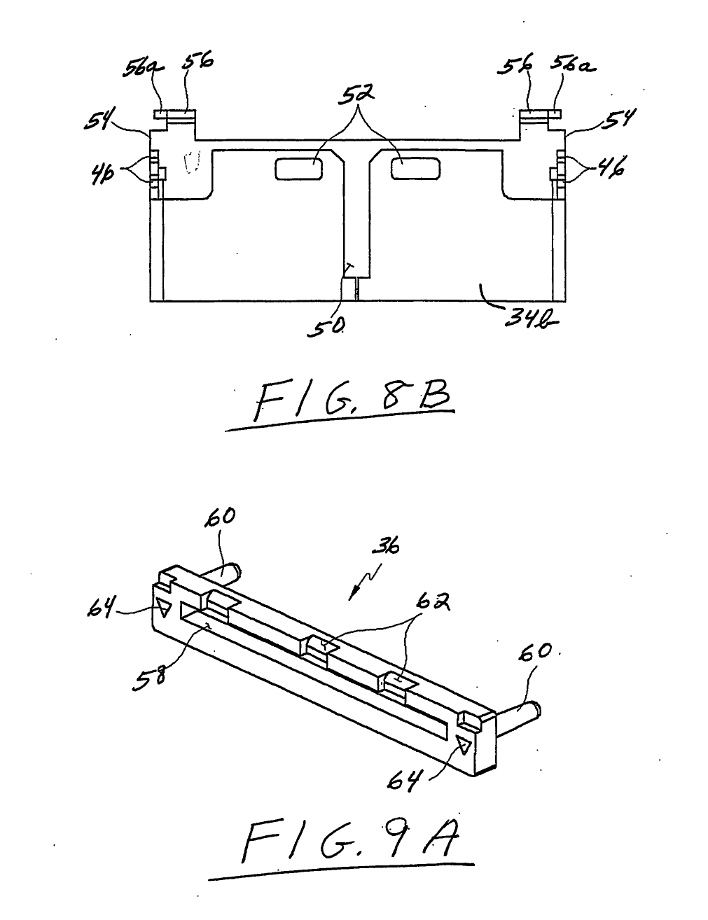

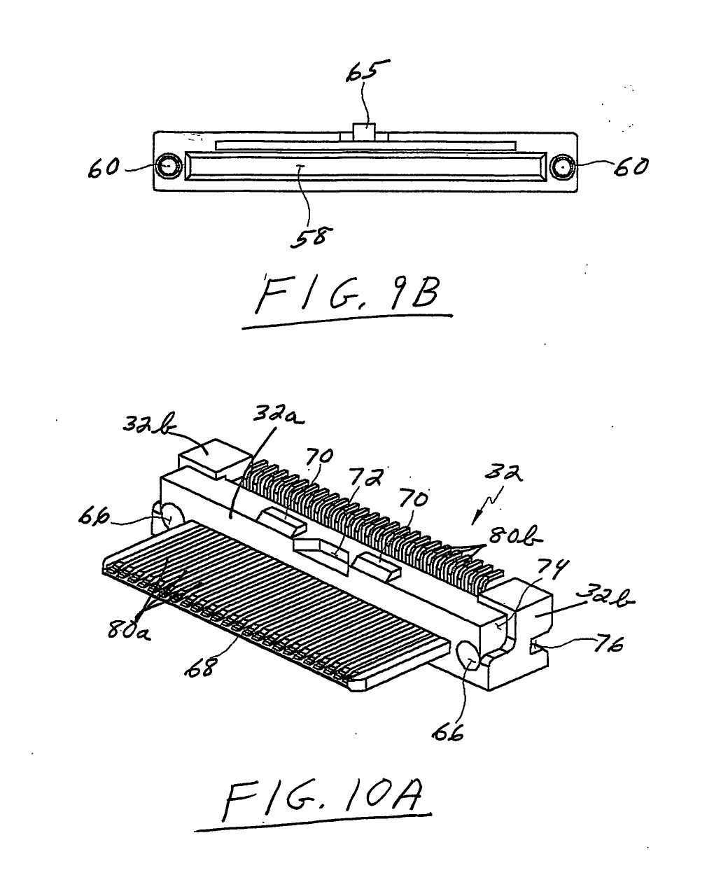

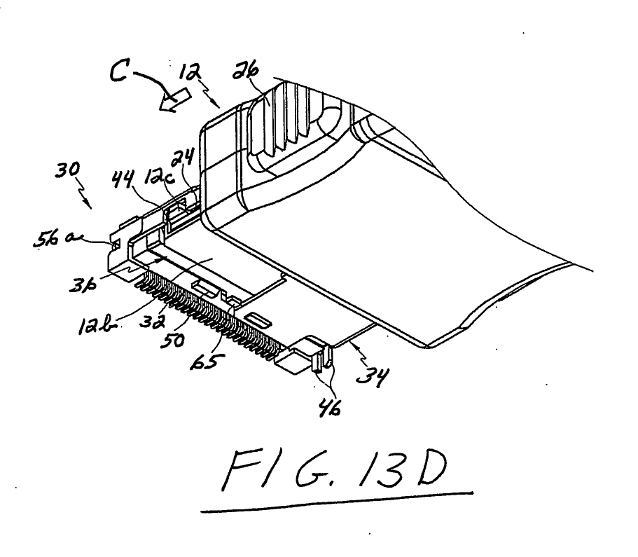

Referring to the drawings in greater detail, and first to FIGS. 3-7, the invention is embodied in an electrical connector, generally designated 30, for mating with a complementary connecting device or mating connector, generally designated 12 in FIGS. 13A and 13B, which corresponds to the mating connector described in the Background, above, in relation to FIGS. 1 and 2. Therefore, the details of mating connector 12 will not be repeated.

Connector 30 according to the invention includes three major components, namely a housing, generally designated 32, substantially surrounded by a shell, generally designated 34, and a shutter, generally designated 36, along with a pair of coil springs 38. Housing 32 and shutter 36 may be fabricated of dielectric material, such as molded plastic material or the like. Shell 34 is a metal shell and may be stamped and formed of sheet metal material.

Referring to FIG. 8A and 8B in conjunction with FIGS. 3-7, metal shell 34 is rectangular and generally elongated to define an internal cavity or receptacle, generally designated 40. The cavity or receptacle has a front opening 40a which receives mating portion 12b of mating connector 12 when the two connectors are mated. The shell has a top wall 34a, a bottom wall 34b joined at a seam 42 and a pair of side walls 34c. A pair of latch openings 44 are formed in the side walls. A pair of bifurcated grounding feet 46 project downwardly from the bottom rear corners of the side walls for insertion into a pair of holes in a printed circuit board and for connection, as by soldering, to appropriate ground traces on the board and/or in the holes. A plurality of stopper tabs 48 are bent downwardly from a top front edge of top wall 34a. A guide slot 50 is formed in bottom wall 34b. A pair of abutment tabs 54 project outwardly from the top rear corners of top wall 34a. A securing tab 56 is bent downwardly from the same top rear corners of the top wall. Locking tabs 56a project outwardly from the outer edges of securing tabs 56.

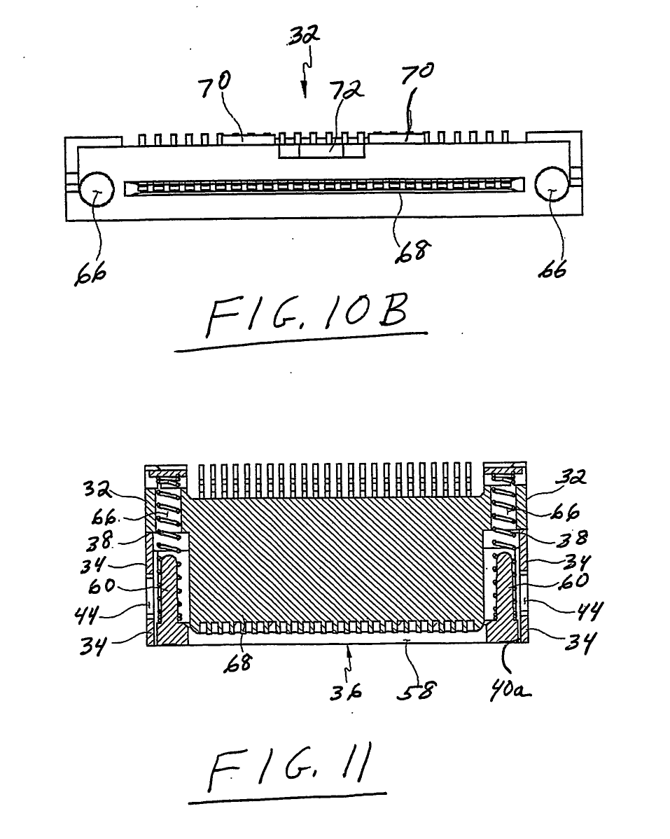

Referring to FIGS. 9A and 9B in conjunction with FIGS. 3-7, shutter 36 of connector 30 is elongated and sized to fill substantially the entirety of the front opening of receptacle 40 of shell 34. The shutter includes an elongated slot or passage 58. A pair of spring-mounting posts 60 project rearwardly from opposite ends of the shutter. A plurality of stopper notches 62 are formed in the top front edge of the shutter for receiving stopper tabs 48 of shell 34. A pair of guide marks 64 are formed in the front face of the shutter. The guide marks are coated with a fluorescent material to be easily recognized. The guide marks also are substantially recessed to facilitate molding of the shutter of plastic material by reducing shrinkage thereof. A guide boss 65 projects downwardly from the shutter.

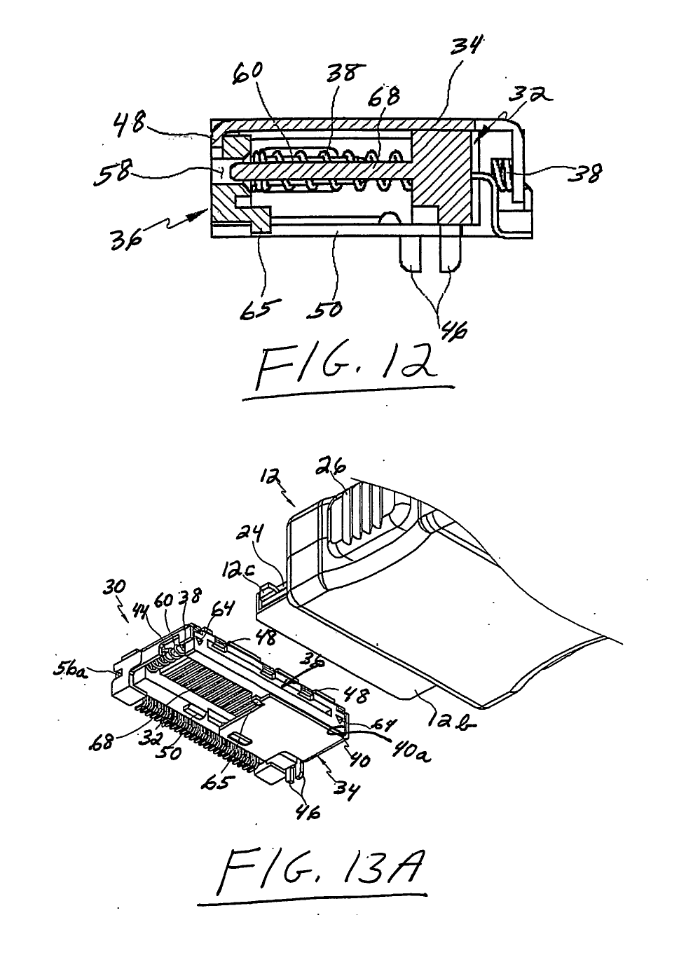

Referring to FIG. 10A and 10B in conjunction with FIGS. 3-7, housing 32 includes an elongated body 32a spanning a pair of wings 32b. A pair of through holes 66 are formed entirely through wings 32b of the housing. A mating portion in the form of a platform 68 projects forwardly of body portion 32a of the housing. A pair of securing bosses 70 project from the bottom of the body of the housing for snapping into the securing openings 52 in the bottom wall of the shell. A boss-receiving recess 72 is formed between securing bosses 70 for receiving the guide boss 65 projecting from the underside of the shutter. A pair of recesses 74 are formed in the outer faces of wings 32 of the housing for receiving the upper portions of grounding feet 76 of the shell. A T-shaped recess 76 is formed in the rear face of each wing 32b for receiving the securing tab 56 and locking tab 56a of the shell.

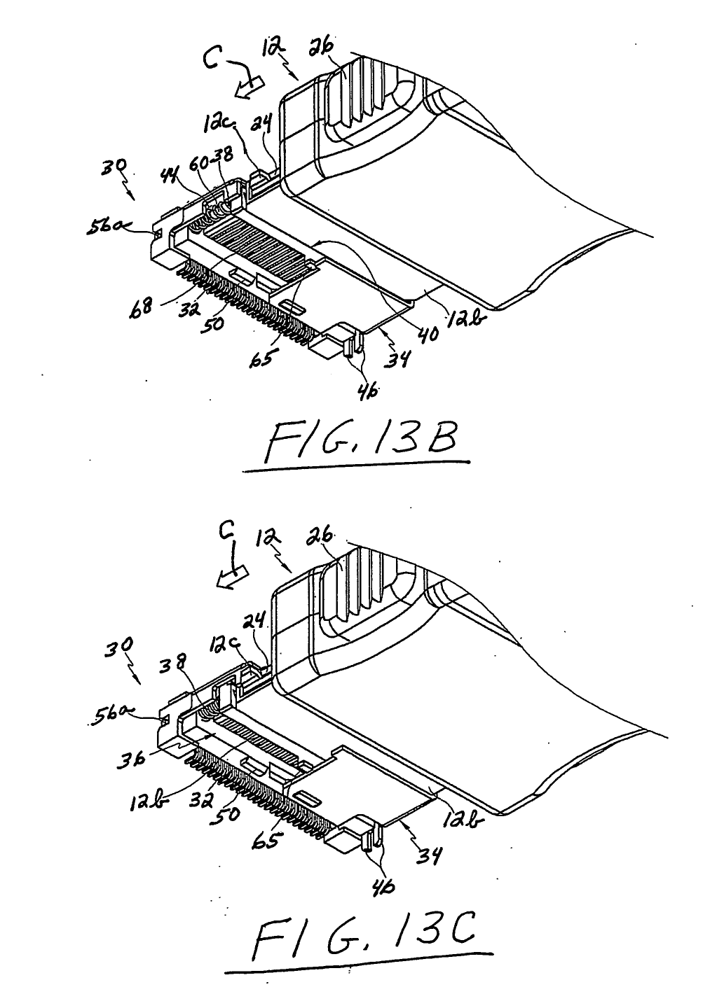

Referring to FIGS. 11 and 12 in conjunction with FIGS. 3-10B, connector 30 is assembled by inserting shutter 36 into the rear of shell 34 in the direction of arrows “B” (FIG. 6) until the front of the shutter abuts against stopper tabs 48 of the shell which seat into stopper notches 62 along the top edge of the shutter. Coil springs 38 then are inserted in the direction of arrows “B” into the rear of the shell, with the front ends of the coil springs positioned over the spring-mounting posts 60 projecting rearwardly of the shutter. Housing 32 then is mounted into the rear of the shell in the direction of arrows “B”, with coil springs 38 extending entirely through the through holes 66 of the housing. This can be seen clearly in FIG. 11. When fully inserted, securing bosses 70 (Fig. 10A) move into securing openings 52 (FIG. 8B) of the shell. The front edges of the securing bosses are chamfered and, with the metal shell being flexible, the securing bosses “snap” into the securing openings. When the housing is fully inserted and secured within the shell, mating platform 68 projects into the internal cavity or receptacle 40 of the shell, and abutment tabs 54 (FIG. 8A) rest on top of wings 32b of the shell. After the housing is fully inserted, securing tab 56, along with locking tab 56a at the rear of the stamped and formed metal shell, are bent downwardly whereby the securing and locking tabs are seated or press-fit into the T-shaped securing recesses at the rear of the housing as clearly seen in FIG. 4.

The assembly operation could be reversed, and housing 32, springs 38 and shutter 36 inserted into the front of metal shell 34. In this instance, tab 56 first would be bent downward. Then, after the housing, the springs and the shutter are assembled opposite the direction of arrows “B”, stopper tabs 48 would be bent downwardly to hold the components in cavity 40.

A plurality of terminals are mounted in body 32a of housing 32. The terminals include contact portions 80a which are positioned in grooves in the bottom face of mating platform 68 as seen clearly in FIG. 10A. The terminals have tail portions 80b which are connected, as by soldering, to appropriate circuit traces on the printed circuit board.

Referring to FIGS. 13A-13C, mating connector 12 is mated with connector 30 in the direction of arrows “C”. During connection, mating portion 12b is inserted into receptacle 40 and into abutment with shutter 36 which closes the open front end of the shutter. This is seen in FIG. 13B. FIGS. 13C and 13D show that the shutter is pushed rearwardly with the mating connector (which can be seen in FIGS. 13C and 13D, with a portion of the bottom wall of the shell removed to facilitate the illustration). As the shutter moves rearwardly, mating platform 68 of connector 30 moves through passage 58 in the moving shutter. When the connectors are fully mated, contact portions 80a of the terminals mounted in housing 32 engage appropriate contacts on mating portion 75 of mating connector 12. When the connectors are fully mated, latch projections 12c of the mating connector snap into latch openings 44 of shell 34 to latch the connectors in mated condition. As described in the Background, above, in order to unmate the connectors, release buttons 26 are pushed to move latch projections 12c out of openings 44 by means of the interconnection of the latch projections to the release buttons by leaf springs 24. When the mating connector is pulled out of receptacle 36 of connector 30, coil springs 38 restore shutter 36 back to its closed position as shown in FIG. 13A. During movement of the shutter, the shutter is stabilized and guided by the guide boss 65 projecting from the underside of the shutter riding in guide slot 50 in the bottom wall of shell 34.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical connector (30) for mating with a complementary connecting device (12) having a mating portion (12b), comprising:
a shell (34) having an internal cavity (40), a front opening (40a) for receiving the mating portion of the complementary connecting device inserted into the cavity;
a housing (32) mounted in at least a rear portion of the shell and having a mating portion (68) extending forwardly into the cavity, and a plurality of stopper tabs (48) bent downwardly from a top front edge of a top wall (34a); and, a shutter (36) slidably mounted in the internal cavity of the shell and formed with a passage (58) for receiving the forwardly extending mating portion of the housing therethrough, whereby when the mating portion (12b) of the complementary connecting device (12) is inserted into the cavity (40) through the front opening in the shell, the shutter (36) is slidably pushed rearwardly from a forward position to a rear position whereat the mating portion (68) of the housing (32) passes through the passage (58) in the shutter for engaging the mating portion of the complementary connecting device.

2. The electrical connector of claim 1, including spring means (38) for biasing the shutter (36) toward its forward position.

3. The electrical connector of claim 2 wherein said spring means comprises a coil spring (38) extending in a direction (B) between the housing (32) and the front opening in the shell (34).

4. The electrical connector of claim 3 wherein said shutter (36) is elongated, and including a pair of said coil springs (38) at opposite ends of the shutter and a plurality of stopper notches (62) formed in a top front edge of the shutter for receiving stopper tabs (48) of shell (34).

5. The electrical connector of claim 3 wherein the shell (34) and the coil spring (38) are of metal material and said housing (32) includes a through hole (66) through which a rear end of the coil spring extends into engagement with a portion (56) of the shell.

6. The electrical connector of claim 3 wherein said shutter (36) includes a rearwardly extending post (60) projecting into a front end of the coil spring (38).

7. The electrical connector of claim 1, including front-to-rear interengaging guide means (50,65) between the shell (34) and the shutter (36).

8. The electrical connector of claim 7 wherein said guide means comprise a guide slot (50) in the shell (34) receiving a guide boss (65) on the shutter (36).

14. An electrical connector (30) for mating with a complementary connecting device (12) having a mating portion (12b), the connector being adapted for mounting on a printed circuit board, comprising:
a metal shell (34) having an internal cavity (40), a front opening (40a) for receiving the mating portion of the complementary connecting device inserted into the cavity, and a plurality of stopper tabs (48) bent downwardly from a top front edge of a top wall (34a), the shell having a grounding portion (46) for connection to the printed circuit board;
a housing (32) mounted in at least a rear portion of the shell and having a through hole (66);
a shutter (36) slidably mounted in the internal cavity of the shell for movement between a forward position substantially closing the front opening of the cavity and a rear position, the shutter including a plurality of stopper notches (62) formed in the top front edge of the shutter for receiving stopper tabs (48) of shell (34) when the shutter is in the forward position; and
a metal spring (38) for biasing the shutter toward its forward position, the metal spring extending through the through hole (66) in the housing and into engagement with the metal shell.

15. The electrical connector of claim 14 wherein said spring is a coil spring (38) extending in a front-to-rear direction, with a rear end of the coil spring extending through the through hole (66) in the housing (32) and into engagement with a rear portion (56) of the metal shell (34).
